(19) United States
(12) Patent Application Publication
(10) Pub. No.: US 2026/0299394 A1
(43) Pub. Date: Oct. 1, 2026

(54) VACUUM PUMP

(71) Applicant: PFEIFFER VACUUM, Annecy (FR)

(72) Inventors: Éric MANDALLAZ, Annecy Cedex (FR); Sylvain CUMONT, Annecy Cedex (FR)

(73) Assignee: PFEIFFER VACUUM, Annecy (FR)

(21) Appl. No.: 19/480,401

(22) PCT Filed: Apr. 8, 2024
(86) PCT No.: PCT/EP2024/059437

§ 371 Date: Oct. 31, 2025

(30) Foreign Application Priority Data
May 2, 2023 (FR) FR2304387

(51) Int. Cl. G03B 21/28; F04B 35/06; F04B 37/14; F04B 41/06

(52) U.S. Cl. CPC G03B 21/28; F04B 35/06; F04B 37/14; F04B 41/06

(57) ABSTRACT

A vacuum pump includes a projector to project at least one piece of information associated with an operating variable of the vacuum pump onto a wall of a protective cover on the front face of the vacuum pump or on a surface in the surroundings of the vacuum pump, in particular on the floor.

The present invention relates to the field of vacuum pumps and notably to vacuum pumps that can be stacked on top of one another, such as those used in semiconductor fabrication plants, for example.

In certain applications, notably for the fabrication of semiconductor components, vacuum pumps are used to reduce the pressure, in particular in process chambers for apparatuses in which the various semiconductor component fabrication steps are carried out, or in inlet or outlet locks of these chambers, or in the transfer chambers.

The apparatuses are arranged in cleanrooms in which particle concentration is controlled and in which temperature and humidity are maintained at a precise level.

Notably because of the noise, vibrations and the heat that they can cause and the space that they can take up, rough-vacuum pumps are generally arranged on the lower floor of the cleanrooms. In addition, in order to limit the floor space taken up, rough-vacuum pumps are generally stacked on top of one another along aisles in the basement.

It needs to be possible to monitor that these vacuum pumps are operating correctly and possible to rapidly identify pump faults requiring possible intervention, including by a non-specialist technician.

For this purpose, vacuum pumps are generally equipped with control boxes allowing operators to control their operating parameters.

However, this information is not immediately available because of the need to manipulate the control box. In addition, navigating through the various menus of the control box may be relatively laborious due to the multitude of advanced functions available.

Furthermore, it is not possible to easily compare the operating parameters of two adjacent vacuum pumps because of the need to access the information in the respective control boxes of the vacuum pumps.

Vacuum pumps may also have indicator lights for indicating their operating state. These indicators, which are generally arranged on the front face, make it possible to display whether the vacuum pump is in a normal, defective or shut-down operating state using a three-color signaling system. However, these indicator lights are correctly visible only within a restricted perimeter of the vacuum pump that corresponds to the light emission cone of these indicators. It is not possible to arrange these indicators in the upper face or in a turret because this would not allow the vacuum pumps to be stacked, or they may not be visible or weakened because of the stacking of the vacuum pumps. In addition, the information provided by these indicators is limited.

Moreover, some vacuum pumps can be arranged very close to the ground or integrated therein, thus making it even more complicated to access the control box or read the indicators.

It would also be possible to transfer the information about the operating state of the pumps to a control room, but then this information would not be readily available in the basement, near to the vacuum pumps in question.

It is therefore necessary to provide a solution that allows rapid access to the status and operating parameters of the various vacuum pumps in a basement comprising a plurality of vacuum pumps that can be stacked on top of one another.

To this end, the invention relates to a vacuum pump comprising a projector configured to project at least one item of information associated with an operating parameter of the vacuum pump onto a wall of a protective cover of the front face of the vacuum pump or onto a surface of the environment of the vacuum pump, notably onto the ground.

According to another aspect of the present invention, the vacuum pump also comprises at least one reflecting mirror for reflecting the light beam emitted by the projector.

According to another aspect of the present invention, the reflecting mirror is orientable.

According to another aspect of the present invention, the reflecting mirror is removable.

According to another aspect of the present invention, the projector is configured to continuously display at least one item of information associated with an operating parameter of the vacuum pump.

According to another aspect of the present invention, the projector is configured to display an item of information associated with an operating parameter of the vacuum pump for a predetermined time and to alternately display, in a predetermined order, different items of information associated with operating parameters of the vacuum pump.

According to another aspect of the present invention, the projector is configured to display an item of information associated with an operating parameter of the vacuum pump in a predetermined color on the basis of the value of the operating parameter of the vacuum pump.

According to another aspect of the present invention, the operating parameter of the vacuum pump is included in the following list:
an electrical operating power of the vacuum pump,
a gas pressure measured at a delivery outlet of the vacuum pump,
an operating temperature of a stator of the vacuum pump,
a flow rate of a purging gas injected into the path of the pumped gases,
an operating fault of the vacuum pump,
an operating duration of the vacuum pump,
an operating state of the vacuum pump,
a temperature of a purging gas injected into the path of the pumped gases.

According to another aspect of the present invention, the vacuum pump comprises a first and a second functional block and the operating parameter of the vacuum pump is included in the following list:
a current consumed by one and/or the other of the functional blocks,
a rotational speed of one and/or the other of the functional blocks.

According to another aspect of the present invention, the projector is configured to display the item of information associated with the operating parameter of the vacuum pump in the form of alphanumeric text and/or symbols and/or pictograms and/or logos.

According to another aspect of the present invention, the vacuum pump is configured to be arranged on another vacuum pump or pumping unit and/or to support another vacuum pump or pumping unit.

The present invention also relates to an apparatus comprising a plurality of vacuum pumps and a projector connected to the plurality of vacuum pumps and configured to project at least one item of information associated with an operating parameter of the plurality of vacuum pumps onto a wall of a protective cover of the front face of at least one of the plurality of vacuum pumps or onto a surface of the environment of the plurality of vacuum pumps, notably onto the ground. One of the vacuum pumps of the plurality of vacuum pumps of the apparatus may correspond to a vacuum pump as described above.

Other features and advantages of the invention will become more clearly apparent upon reading the following description, which is provided by way of illustrative and nonlimiting example, and the appended drawings, in which:

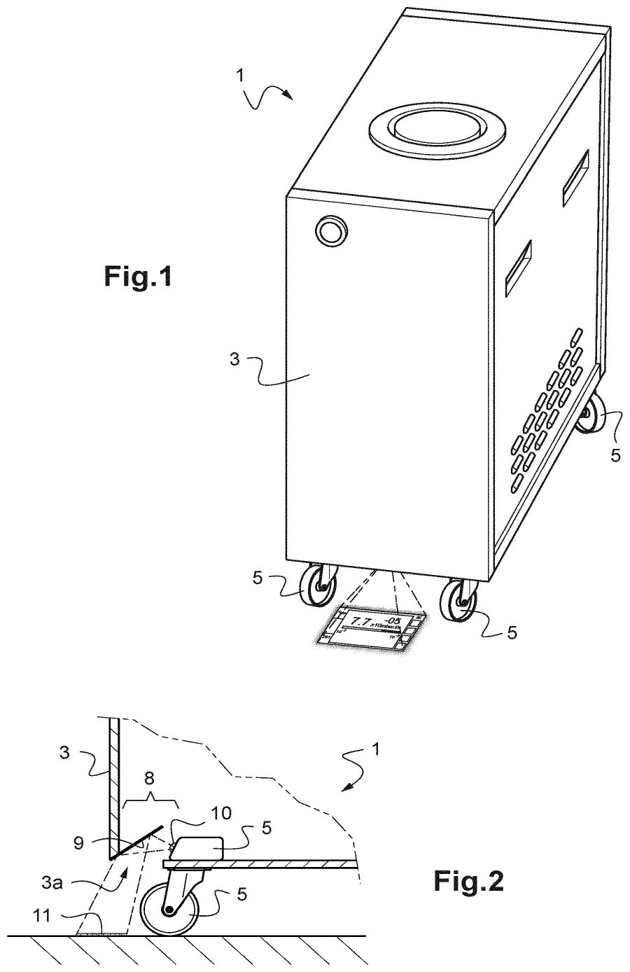

FIG. 1 shows a schematic perspective view of a vacuum pump according to a first embodiment of the present invention;

FIG. 2 shows a schematic side view of part of a vacuum pump according to a first embodiment of the present invention;

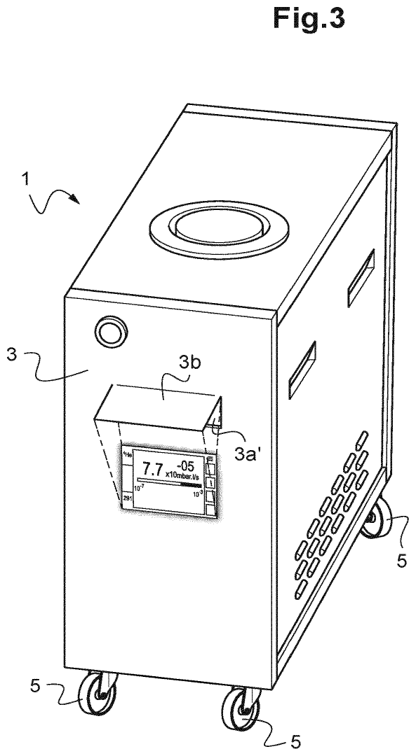

FIG. 3 shows a schematic perspective view of a vacuum pump according to a second embodiment of the present invention;

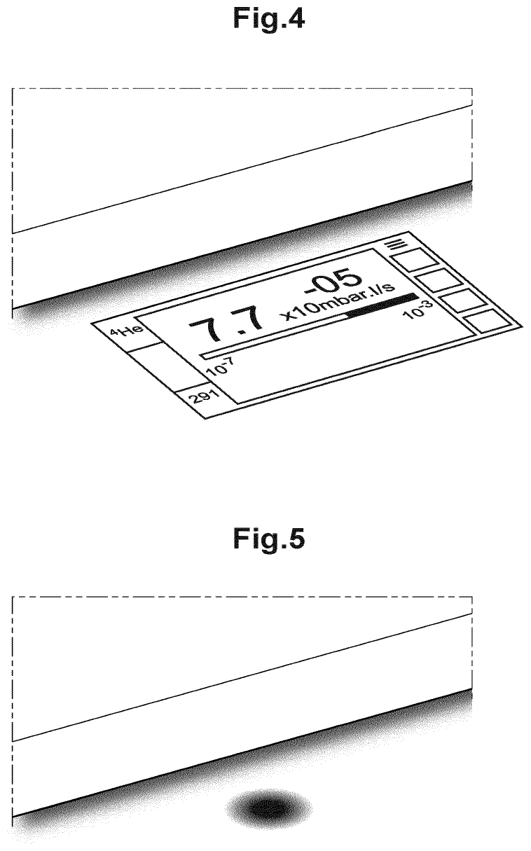

FIG. 4 shows a schematic view of a first type of projected display;

FIG. 5 shows a schematic view of a second type of projected display;

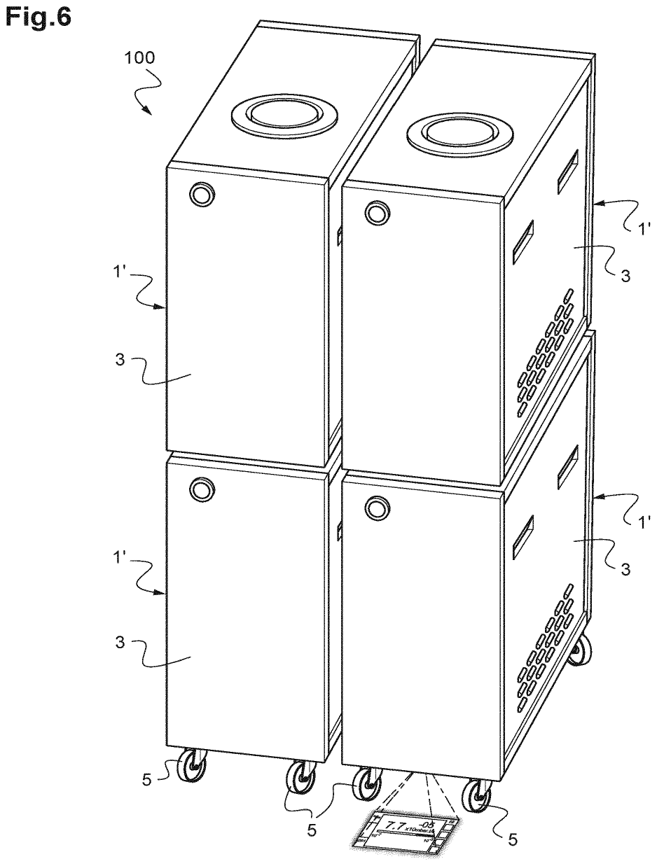

FIG. 6 shows a schematic perspective view of an apparatus comprising a plurality of vacuum pumps and a projector according to a first embodiment;

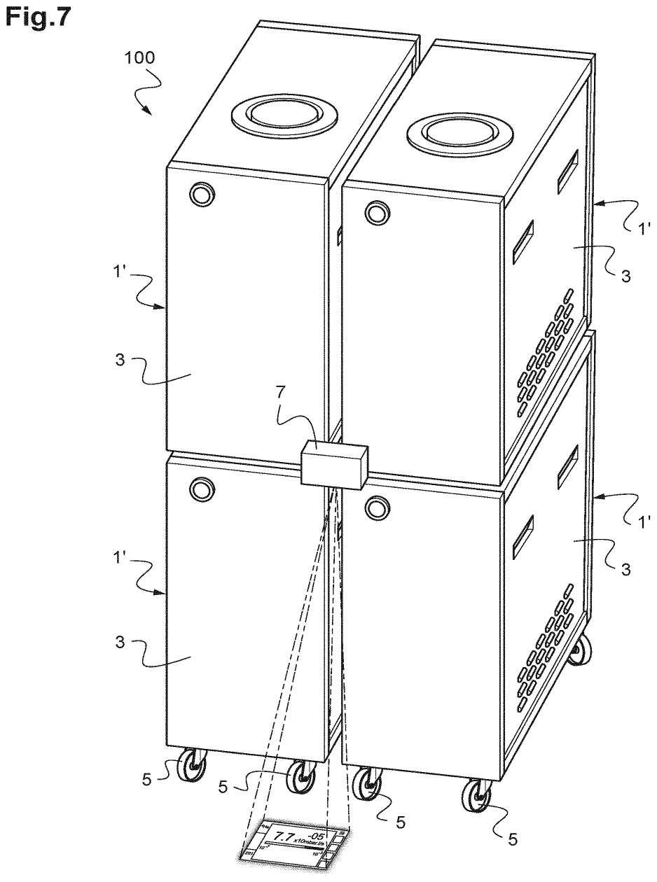

FIG. 7 shows a schematic perspective view of an apparatus comprising a plurality of vacuum pumps and a projector according to a second embodiment;

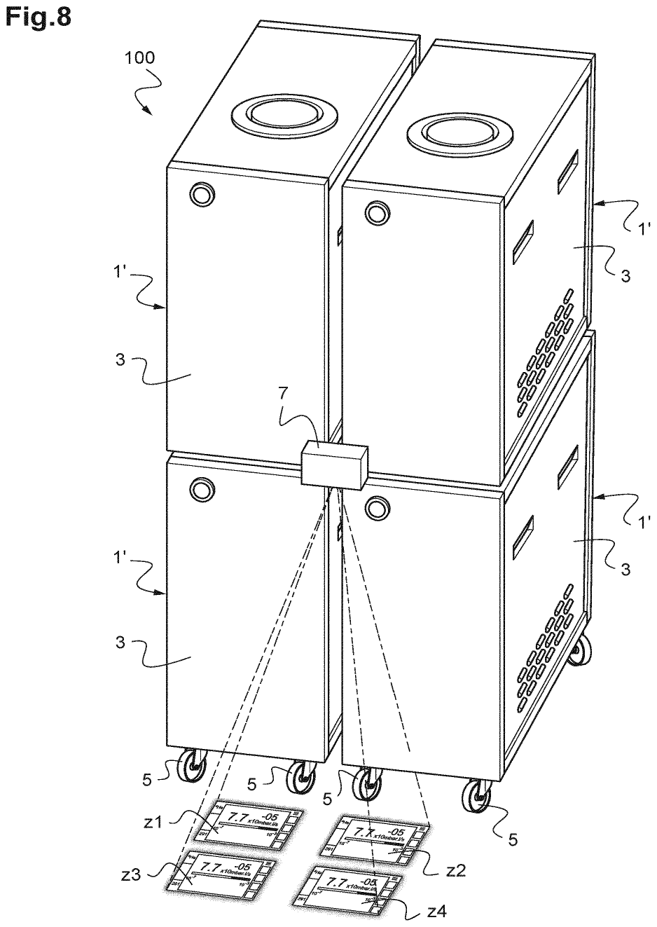

FIG. 8 shows a schematic perspective view of an apparatus comprising a plurality of vacuum pumps and a projector according to a third embodiment.

In these figures, identical elements bear the same reference signs.

The following embodiments are examples. Although the description refers to one or more embodiments, this does not necessarily mean that each reference relates to the same embodiment, or that the features apply only to a single embodiment. Individual features of different embodiments may also be combined or interchanged to provide other embodiments.

The present invention relates to a vacuum pump, notably for use in a semiconductor fabrication plant for controlling the pressure notably of the process chambers. FIG. 1 shows such a vacuum pump 1. The vacuum pump 1 is, for example, a single pump or a pumping unit that can comprise a plurality of functional units, each functional unit being able to comprise several stages arranged in series. The vacuum pump 1 may also comprise a roots pump so as to form a high-vacuum pump combined with a rough-vacuum pump.

The vacuum pump 1 comprises a protective cover 3 and may comprise wheels 5 in order to make it easier to move. The protective cover 3 has, for example, a parallelepipedal overall shape that allows the vacuum pump 1 to be stacked. The vacuum pump 1 can be positioned beneath another vacuum pump 1 or another pumping unit or on top of another vacuum pump 1 or another pumping unit or placed on the ground. The pumps may also be arranged on supports arranged one above the other.

The vacuum pump 1 also comprises a projector 7 (visible in FIG. 2) configured to project an item of information associated with an operating parameter of the vacuum pump 1. The item of information may be projected onto the ground beneath the vacuum pump 1 or in a zone situated in front of the vacuum pump 1 as in the case of FIGS. 1 and 2. The item of information may also be projected onto a surface of the environment of the vacuum pump 1, notably another vacuum pump 1 or a pumping unit if the vacuum pump 1 is situated above another vacuum pump 1 or a pumping unit or onto a partition or a wall of another apparatus situated near to the vacuum pump 1.

The item of information may be projected directly by the projector 7 or via an optical device 8 comprising, for example, one or more reflecting mirrors 9 for reflecting the light beam emitted by the projector 7 and/or one or more lenses 10 configured to focus the light beam.

The optical device 8 is configured to allow the item of information to be projected in the desired direction and to easily modify this direction, notably in the event of the vacuum pump 1 being moved. Thus, the one or more mirrors 9 can be orientable in order to allow direct projection or to adapt the projection direction (some directions may require a larger number of mirrors and therefore the mirrors may be removable). The optical device 8 may also be configured to modify the size of the display and/or adjust the sharpness of the display of the item of information. For this purpose, the optical device 8 may be configured to allow the position of the one or more lenses to be adjusted.

FIG. 2 shows an example of an optical device 8 comprising a lens 10 and a reflecting mirror 9 configured to reflect the light beam emitted by the projector 7 toward the ground 11, just in front of the vacuum pump 1, as shown in FIG. 1.

A larger number of mirrors 9 and/or lenses 10 may also be used to obtain the desired projection.

The mirrors 9 may be orientable and the lenses 10 may be adjustable (for example movable in translation) in order to adapt to the environment of the pump 1 and to provide a sharp projected image on surfaces having different orientations with respect to the vacuum pump 1 and/or being situated at different distances from the vacuum pump 1.

The protective cover 3 comprises, for example, an aperture 3a in order to allow the light beam to pass through. This aperture 3a may also be obstructed by a transparent element such as a glass pane or a screen made of polycarbonate or Plexiglas® or any other material providing sufficient transparency.

According to another embodiment, which is presented in FIG. 3, the projector 7 and the optical device 8 are configured to project the item of information onto the wall of the protective cover 3 associated with the front face of the vacuum pump 1.

For this purpose, the protective cover 3 comprises, for example, an aperture 3a′, which is arranged on the front face and can be obstructed by a transparent element, and a protrusion 3b protruding from the front face of the protective cover 3 and configured to at least partially face the aperture 3a′. The protrusion 3b forms, for example, an angle of between 15 and 45° with respect to the front face of the protective cover 3 and receives a reflecting mirror 9 configured to reflect a light beam coming from the projector 7 (situated inside the protective cover 3) toward the front face of the protective cover 3.

The optical device 8 may comprise other mirrors 9 situated inside the protective cover 3 and configured to reflect the light beam coming from the projector 7 toward the mirror 9 positioned on the protrusion 3b. As in the preceding embodiment, the optical device 8 may also comprise lenses 10 that make it possible to adjust the sharpness of the projected image. The protrusion may also have other shapes, such as a curved shape or any other shape that makes it possible to project the light beam onto the front face of the protective cover 3.

The projected item of information corresponds to an item of information associated with an operating parameter of the vacuum pump 1.

For example, the operating parameter is selected from the following list:
an electrical operating power of the vacuum pump 1,
a gas pressure measured at a delivery outlet of the vacuum pump 1,
an operating temperature of a stator of the vacuum pump 1,
a flow rate of a purging gas injected into the path of the pumped gases,
an operating fault of the vacuum pump 1,
an operating duration of the vacuum pump 1,
an operating state of the vacuum pump 1,
a temperature of a purging gas injected into the path of the pumped gases.

In the case in which the vacuum pump 1 comprises at least two functional blocks, the operating parameter may also be selected from the following list:
a current consumed by one and/or the other of the functional blocks,
a rotational speed of one and/or the other of the functional blocks.

The vacuum pump 1 may be configured to project the item of information associated with the operating parameter continuously when the vacuum pump 1 is operating.

The vacuum pump 1 may also be configured to display the items of information associated with a plurality of operating parameters, notably operating parameters from the above list. A plurality of items of information may be displayed simultaneously, as shown in FIG. 4. The items of information may also be displayed alternately in a predefined order and for a predefined time, which may be the same for all of the items of information or vary from one item of information to another. The items of information may be displayed continuously when the vacuum pump is operating or at predefined intervals.

In addition, the items of information may be displayed monochromatically or in different colors.

The display may be in the form of alphanumeric text and/or symbols and/or pictograms and/or logos, as shown in FIG. 4.

The display indicates, for example, the name of the parameter and a number associated with a value of the operating parameter and possibly a unit.

The display may also comprise icons.

The display may comprise different colors associated with different values of the operating parameters or different operating states of the vacuum pump 1 associated with ranges of values of the operating parameters of the vacuum pump 1, as shown in FIG. 5. A green color is, for example, associated with a normal operating state, an orange color is associated with a defective operating state requiring intervention, while a red color may be associated with the shut-down operating state of the vacuum pump 1 following a major fault. Thus, the display color may be changed according to a criticality level reached by the value of the operating parameter measured.

The display may also be intermittent and the frequency may be associated with the state of the vacuum pump 1. An anomalous value of an operating parameter may, for example, be represented by a flashing mode.

The present invention also relates to an apparatus 100 comprising a plurality of vacuum pumps 1′, for example four vacuum pumps 1′ in the example of FIGS. 6 to 8, and a projector 7 connected to the various vacuum pumps 1′ and configured to display at least one item of information associated with an operating parameter of the vacuum pumps 1′. The connection between the projector 7 and the vacuum pumps 1′ may be a wired connection or a wireless connection, for example a Bluetooth® connection. The vacuum pumps 1′ may be arranged side by side and/or stacked on top of one another. The projector 7 may be integrated into one of the vacuum pumps 1′ (as in FIG. 6) or may be independent of the vacuum pumps, as shown in FIGS. 7 and 8 (the projector 7 may then be placed on top of one of the vacuum pumps 1′ or arranged so as to be adjacent or nearby (i.e. in the same room as the vacuum pumps 1′)). The features of the projector 7 may be similar to the features presented in the embodiment of a vacuum pump 1 having a projector 7 described above. Thus, the projection zone may also be a wall of a protective cover of the front face of at least one of the plurality of vacuum pumps 1′.

The projector 7 may be configured to simultaneously or sequentially display the items of information associated with the operating parameter(s) of the various pumps 1′. As before, the display of an item of information associated with an operating parameter having a value outside a predetermined operating range may be displayed as a priority (only this item of information may be displayed) and/or differently than the other items of information, for example using a different color and/or using an intermittent (flashing) display and/or in a larger font.

The projector 7 may also be configured to divide the display into different projection zones, for example four zones z1, z2, z3, z4 associated with the four vacuum pumps 1′ in the case of FIG. 8, so that the items of information associated with the various vacuum pumps 1′ are displayed in different zones that may be situated in front of the associated vacuum pumps, as shown in FIG. 8. It is possible to envision a different number of zones than the number of vacuum pumps (the display associated with a plurality of pumps is then carried out in the same zone). Using multiple display zones enables a vacuum pump that has an anomalous operating parameter to be rapidly detected and identified.

Such an apparatus makes it possible, using a single projector 7, to display the items of information associated with the operating parameter(s) of various vacuum pumps 1′, thus making it possible to reduce the costs associated with projecting data while at the same time making it possible to rapidly detect a defective pump.

Thus, the use of a vacuum pump 1 or an apparatus 100 comprising a plurality of vacuum pumps 1′ comprising a projector 7 configured to project data or items of information associated with an operating parameter of the vacuum pump 1 or the vacuum pumps 1′ enables an operator to have rapid access to these items of information even if the vacuum pumps 1 are stacked.

The operator can thus very rapidly detect a failure or malfunction of one vacuum pump 1 from among a set of vacuum pumps 1 grouped in a room or a basement in which the available space is restricted. Displaying non-standard parameters can enable the operator to rapidly identify the origin of the possible failure or to prevent such a failure by taking preventive action, such as maintenance of the vacuum pump 1. Rapidly identifying the defective or non-standard pump and the origin of the failure makes it possible to prevent a failure or, in the event of a failure, to improve the efficiency of the repair and thus to reduce the downtime of the vacuum pump 1 and therefore of the associated production line.

1-11. (canceled)

12. A vacuum pump, comprising:
a projector configured to project at least one item of information associated with an operating parameter of the vacuum pump onto a wall of a protective cover of a front face of the vacuum pump or onto a surface of an environment of the vacuum pump.

13. The vacuum pump as claimed in claim 12, wherein surface of the environment is the ground.

14. The vacuum pump as claimed in claim 12, further comprising at least one reflecting mirror to reflect a light beam emitted by the projector.

15. The vacuum pump as claimed in claim 14, wherein the reflecting mirror is orientable.

16. The vacuum pump as claimed in claim 14, wherein the reflecting mirror is removable.

17. The vacuum pump as claimed in claim 12, wherein the projector is configured to continuously display the at least one item of information associated with the operating parameter of the vacuum pump.

18. The vacuum pump as claimed in claim 12, wherein the projector is configured to display the item of information associated with the operating parameter of the vacuum pump for a predetermined time and to alternately display, in a predetermined order, different items of information associated with operating parameters of the vacuum pump.

19. The vacuum pump as claimed in claim 12, wherein the projector is configured to display the item of information associated with the operating parameter of the vacuum pump in a predetermined color based on a value of the operating parameter of the vacuum pump.

20. The vacuum pump as claimed in claim 12, wherein the operating parameter of the vacuum pump is included in the following list:
an electrical operating power of the vacuum pump,
a gas pressure measured at a delivery outlet of the vacuum pump,
an operating temperature of a stator of the vacuum pump,
a flow rate of a purging gas injected into a path of pumped gases,
an operating fault of the vacuum pump,
an operating duration of the vacuum pump,
an operating state of the vacuum pump,
a temperature of a purging gas injected into the path of the pumped gases.

21. The vacuum pump as claimed in claim 12, further comprising a first and a second functional block and wherein the operating parameter of the vacuum pump is included in the following list:
a current consumed by the first and/or the second functional block,
a rotational speed of the first and/or the second functional block.

22. The vacuum pump as claimed in claim 12, further comprising a protective cover, which has a parallelepipedal overall shape and is configured to be arranged on an other vacuum pump or pumping unit and/or to support the other vacuum pump or pumping unit.

23. An apparatus, comprising:
a plurality of vacuum pumps; and
a projector connected to the plurality of vacuum pumps and configured to project at least one item of information associated with an operating parameter of the plurality of vacuum pumps onto a wall of a protective cover of a front face of at least one of the plurality of vacuum pumps or onto a surface of an environment of the plurality of vacuum pumps.

24. The apparatus as claimed in claim 23, wherein surface of the environment is the ground.
